(19) United States
(12) Patent Application Publication
(10) Pub. No.: US 2015/0242483 A1
(43) Pub. Date: Aug. 27, 2015

(54) ELASTIC EXECUTION OF CONTINUOUS MAPREDUCE JOBS OVER DATA STREAMS

(71) Applicant: SYDDANSK UNIVERSITET, Odense M (DK)

(72) Inventors: Yongluan Zhou, Odense M (DK); Kasper Grud Skat Madsen, Odense M (DK)

(21) Appl. No.: 14/419,354

(22) PCT Filed: Jul. 29, 2013
(86) PCT No.: PCT/EP2013/065895

§ 371 Date: Feb. 3, 2015

Related U.S. Application Data
(60) Provisional application No. 61/679,164, filed on Aug. 3, 2012.

(51) Int. Cl. G06F 17/30; H04L 12/917

(52) U.S. Cl. CPC G06F 17/30584; H04L 47/76; G06F 17/30917

(57) ABSTRACT

There is provided a set of methods describing how to elastically change the resources used by a MapReduce job on streaming data while executing.

### FIELD OF THE INVENTION

The present invention relates to data processing systems and methods, and in particular to a set of methods describing how to elastically change the resources used by MapReduce job on streaming data while executing.

### BACKGROUND OF THE INVENTION

Large-scale data processing involves extracting data of interest from raw data in one or more datasets and processing it into a useful data product. The implementation of large-scale data processing in a parallel and distributed processing environment typically includes the distribution of data and computations among multiple disks and processors to make efficient use of aggregate storage space and computing power.

MapReduce has been well recognized as an effective computation framework for large scale data analysis. By dividing the work into a set of independent map tasks followed with reduce tasks, it is possible to express the programming logic on processing large volume of data in an easy and efficient approach. With its attractive features such as elasticity, scalability, and finegrained fault tolerance, MapReduce has been widely adopted in both research and production.

MapReduce has a straight-forward yet expressive computation semantic to describe a complicated distributed execution. It adopts a two-phase execution: a map function is applied on each tuple of data and generates a list of key-value pairs, and a reduce function collects the list of pairs with the same key and applies one or more functions to it.

The elasticity in vanilla MapReduce, however, is not flexible. Upon the submission of a MapReduce job, the number of computation resources is calculated based on the job requirement and current available resources. When resources (processing nodes) are added/removed, the system is aware of the change, and future jobs can utilize the new set of resources. However, elasticity during the processing of a job cannot be easily supported. Intra-job elasticity, i.e. computation resources changes dynamically within the same processing, is an attractive feature in long-running jobs such as stream processing.

Data streams are potentially never ending, making it difficult to apply standard operators. This problem is often solved by using windows, which divides the data streams into smaller chunks, which can then be processed. A general system might support several different windows over the same data and execution. For instance calculating the unique visitors for a webpage over one year, one month and one day. That means in a general system, the length of the windows might potentially be very long. If trying to scale resources in a naïve way, it requires the system to wait until all the windows have finished processing. This might potentially take a very long time and in this example, a year. The set of methods defined in this document specifies how to scale much faster.

Accordingly, there is a need for large-scale data processing, which automatically handles programming details associated with parallelization, distribution, and fault-recovery.

### SUMMARY OF THE INVENTION

The present invention provides methods for large-scale data processing that automatically handle programming details associated with parallelization, distribution, and fault-recovery. In some embodiments, application programmers can process large amounts of data by specifying map and reduce operations. The map operations retrieve data from input data files and produce intermediate data values in accordance with the mapping operations. The reduce operations merge or otherwise combine the intermediate data values in accordance with the reduce operations.

The invention provides a set of methods for changing the resources of a MapReduce job on streaming data while executing. One method defines splitting a component. One method defines combining functions into a component. One method defines how to add mappers to a component. One method defines how to remove mappers from a component. One method describes adding reducers to a component. One method describes removing reducers from a component. Splitting a component will split the logic of the component between two components. Combining the component will move functions, from two components, onto one component. Splitting a component can under the right circumstances prevent bad performance because of skewed data.

In a first aspect of the present invention there is provided a method to split the computing logic of one component, onto two components, in a job which can be specified using Map and Reduce computing units, during execution of the job, said method comprising the steps of:
Sending a message A from any component, before the first component in the job, containing either Map or Reduce computing units;
Changing the components sending data to the component to split, to shuffle output, upon receiving message A;
Changing the component to split to create partial results, upon receiving message A;
Changing the component to split to send output so that data with the same key is sent to the same computing unit, upon seeing message A;
Changing the components receiving data from the component to split, to handle partial results, upon seeing message A;

wherein;
the component is a set of computing units of the same type using the same execution logic;
a Map computing unit is a unit, which is partitioning data;
a Reduce computing unit is doing aggregation and applying some function to the aggregated data; and
a message is data, which controls the execution logic.

In a second aspect of the present invention there is provided a method to combine a component, whose computing logic is split over two components, onto one component, in a job which can be specified using Map and Reduce computing units, during execution of the job, said method comprising the steps of:
Sending a message A from any component, before the first component in the job, containing either Map or Reduce computing units;
Changing the components sending data to the component to combine onto, to send output in such a way, data with same key is sent to the same computing unit, upon receiving message A;
Checking if data being calculated on the component to combine onto is no longer partial and the previous processed partial data is no longer needed;
Sending a message B from any component, before the first component in the job, containing either Map or Reduce computing units;
Changing the component to combine onto, to begin creating complete results upon receiving message B;
Changing the components receiving from the component to combine onto, to stop handling partial results, upon receiving message B;

wherein;
the component is a set of computing units of the same type using the same execution logic;
a Map computing unit, is a unit, which is partitioning data;
a Reduce computing unit is doing aggregation and applying some function to the aggregated data; and
a message is data which controls the execution logic.

In a third aspect of the present invention there is provided a method to add one or more mappers to a component, in a job which can be specified using Map and Reduce computing units, during execution of the job, said method comprising the steps of:
Checking if the current component, is handling partial results;
Combine the logic back onto the components sending to the current component;
Starting new mappers for the component to add mappers to;
Updating the connections in the job;

wherein;
the component is a set of computing units of the same type using the same execution logic;
a Map computing unit, is a unit which is partitioning data;
a Reduce computing unit is doing aggregation and applying some function to the aggregated data;
a message is data which controls the execution logic; and
the component to add mappers to is defined as the current component.

In a fourth aspect of the present invention there is provided a method to remove one or more mappers from a component, in a job which can be specified using Map and Reduce computing units, during execution of the job, said method comprising the steps of:
Checking if current component is handling partial results;
Combine the logic of the components sending to the current component;
Stopping generation of new data for the mappers to remove;
Checking if all is received, processed and sent on the mappers to remove;
Stopping and removing mappers;
Updating the connections in the job;

wherein;
the component is a set of computing units of the same type using the same execution logic;
a Map computing unit is a unit, which is partitioning data;
a Reduce computing unit is doing aggregation and applying some function to the aggregated data;
a message is data which controls the execution logic; and
the component to remove mappers from is defined as the current component.

In a fifth aspect of the present invention there is provided a method to add one or more reducers to a component, in a job which can be specified using Map and Reduce computing units, during execution of the job, said method comprising the steps of:
Checking if current component is handling partial results;
Combine the logic of the components sending to the current component;
Checking if current components computing logic is split over two components;
If not already spilt then split the logic of the current component onto two components;
Starting new reducers for the current component; and
Updating the connections in the job;

wherein;
the component is a set of computing units of the same type using the same execution logic;
a Map computing unit is a unit which is partitioning data;
a Reduce computing unit is doing aggregation and applying some function to the aggregated data;
a message is data which controls the execution logic; and
the component to add reducers to is defined as the current component.

In a sixth aspect of the present invention there is provided a method to remove one or more reducers from a component, in a job which can be specified using Map and Reduce computing units, during execution of the job, said method comprising the steps of:
Checking if current component is handling partial results;
Combine the logic of the components sending to the current component;
Checking if current components computing logic is split over two components;
Split the logic of the current component onto two components;
Stopping generation of new data for the reducers to remove on the current component;
Checking if all data has been received, processed and sent from the reducers to remove, on the current component;
Stopping sending messages for reducers to remove on the current component if the message has no relevance for the data at the reducers to remove;
Checking if all input on all the reducers to remove on the current component has been received, processed and sent;
Stopping and removing reducers to remove on the current component; and
Updating the connections in the job;

wherein;
the component is a set of computing units of the same type using the same execution logic;
a Map computing unit is a unit which is partitioning data;
a Reduce computing unit is doing aggregation and applying some function to the aggregated data;
a message is data, which controls the execution logic; and
the component to remove reducers from is defined as the current component.

In a seventh aspect of the present invention, there is provided three alternative methods to the above mentioned methods.
An alternative strategy to combine a component, whose logic is split over multiple components, into one component;
An alternative strategy to add reducers to a component;
An alternative strategy to remove reducers from a component;

### BRIEF DESCRIPTION OF THE DRAWINGS

FIG. 1 provides an overview of the methods of the present invention.

FIG. 2 shows how a component consisting only of reducers is split in accordance with the present invention.

FIG. 3 shows how a component consisting only of reducers is combined in accordance with the present invention.

FIG. 4 shows how a component is added in accordance with the present invention.

FIG. 5 shows how mappers are removed from a component in accordance with the present invention.

FIG. 6 shows how reducers are added to a component in accordance with the present invention.

FIG. 7 shows how reducers are removed from a component in accordance with the present invention.

FIG. 8 shows an alternative strategy, to how a component consisting only of reducers is combined in accordance with the present invention.

FIG. 9 shows an alternative strategy, to how reducers are added to a component in accordance with the present invention.

FIG. 10 shows an alternative strategy, to how reducers are removed from a component in accordance with the present invention.

### DETAILED DESCRIPTION OF THE INVENTION

### Definitions

Data is defined as the data used for computation. Messages are defined as data controlling the execution. A job in a streaming system can be modeled by a directed acyclic graph, where the vertices represents sets of functions, denoted components, and the edges represents the connections between the components, allowing data and messages to be sent between the components. To clarify, consider the example below.

### EXAMPLE 1

Source (1)-->Mappers (2)-->Reducers (3)-->Mappers (4)-->Reducers (5)

Each element in the figure above is a component. Each component has an id. The first component is the one with id=1.

For convenience we define the current component as the component to change (for instance splitting it). The set of components sending data to the current component is called the previous component and the set of components receiving data from the current component is called the next component. The first component is defined to be any component between the head component and any component located before the first computing component. For clarity consider this example.

### EXAMPLE 2

This example uses the figure of Example 1. If splitting the component with id 3, the current component is the component with id 3, the previous component is the component with id 2 and the next component is the one with id 4.

We define a mapper as any stateless computing unit that applies one or more functions to a piece of data and generates a key used for partitioning. A reducer is defined as one or more computing units that aggregates data and applies one or more functions on the aggregated data. For example can a reducer consist of two functions, one doing aggregation and another applying a function on the aggregated data.

### Interconnections Between the Methods

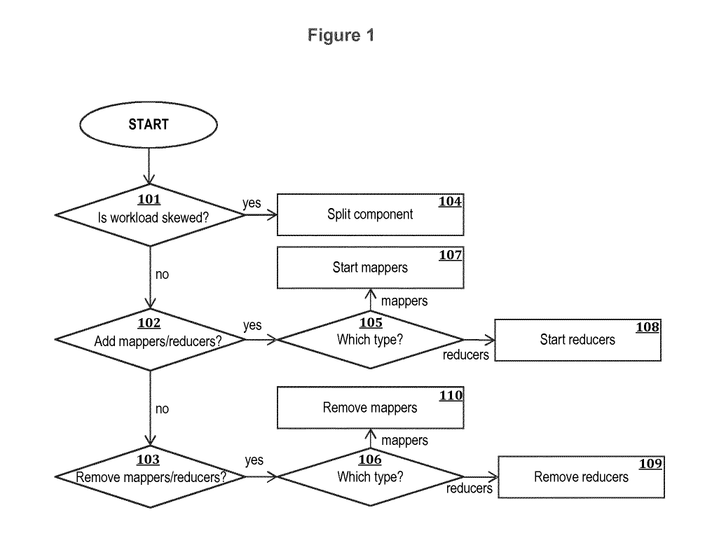

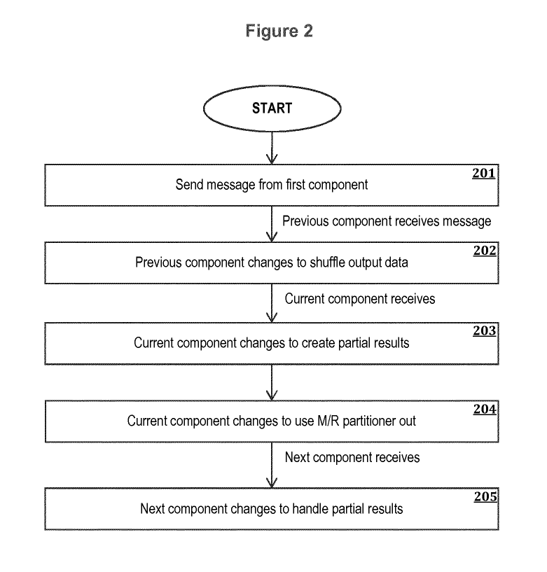

FIG. 1 is a flow diagram depicting how the methods defined in this document are connected to each other and how they could be used by a general system. This depiction and following description is only for clarity and appreciation of the methods. Checking if the workload over a component is skewed 101. If a workload is skewed the method from FIG. 2 can be used to split the component 104. Splitting the component will potentially improve performance as data will be shuffled into the current component solving the problem of skewness.

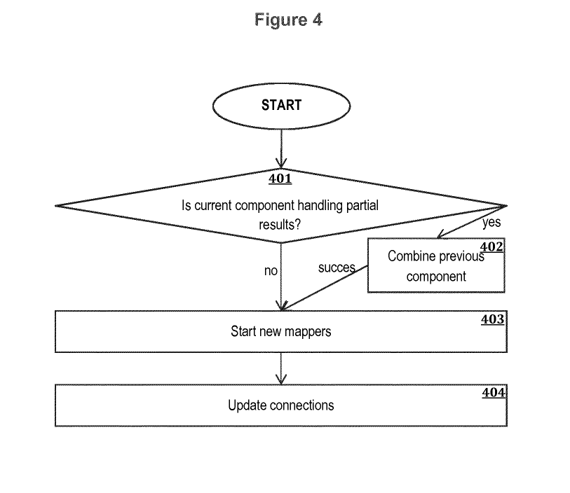

Check if it would be beneficial to add either mappers or reducers to a component 102. The component to add to is then decided 105. Then either mappers 107 or reducers 108 can be started using the methods depicted in FIGS. 4, 6 and 9.

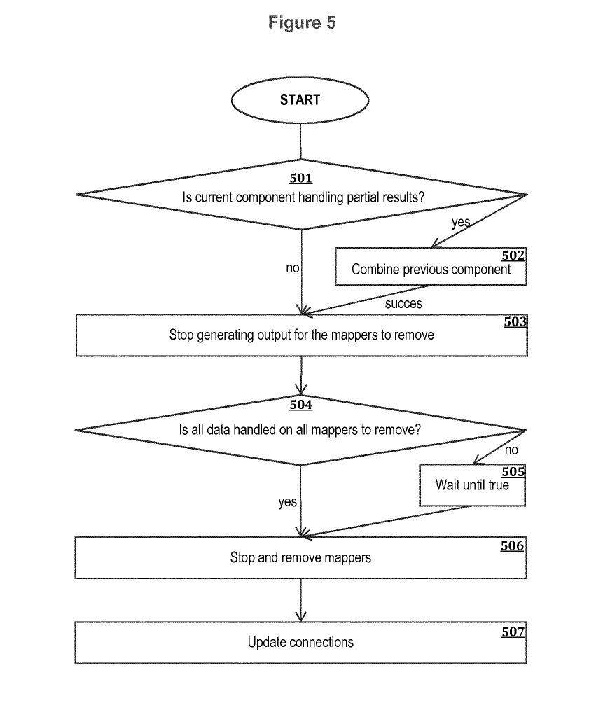

Check if it would be beneficial to remove mappers or reducers from a component 103. The component to remove from is then decided 106. Then either mappers 109 or reducers 110 can be removed from a component by using the methods depicted in FIGS. 5,7 and 10.

### Method to Split Component

FIG. 2 is a flow diagram depicting a method of splitting the logic of a component, onto two components, while executing.

The method starts by sending a message from the first component 201. The message will be propagated along all the components to one at a time, in the order from first to last. When seen by the previous component, the previous component should begin shuffling its output 202. The previous component will propagate the message along to the current component, which should change to create partial results 203. The current component should also begin using the MapReduce grouping from the previous component to output data 204. Then the current component propagates the message to the next component. The next component sees the message and should be changed to handle the partial results 205.

There might be several ways to split the logic of a reducer onto two components. Our description is not limited to one specific way of doing it. For clarity we give an example of how it could be done. Define a reducer with two functions, calculate and finalize. Calculate will compute partial results which can then be “combined” into one final result by the finalize function. The calculate function can be run on the current component and the finalize function on the next component. It works because the current component uses the MapReduce grouping from the previous component, which ensures data with the same key will be sent to the same computing unit.

### Method to Combine Functions Into a Component

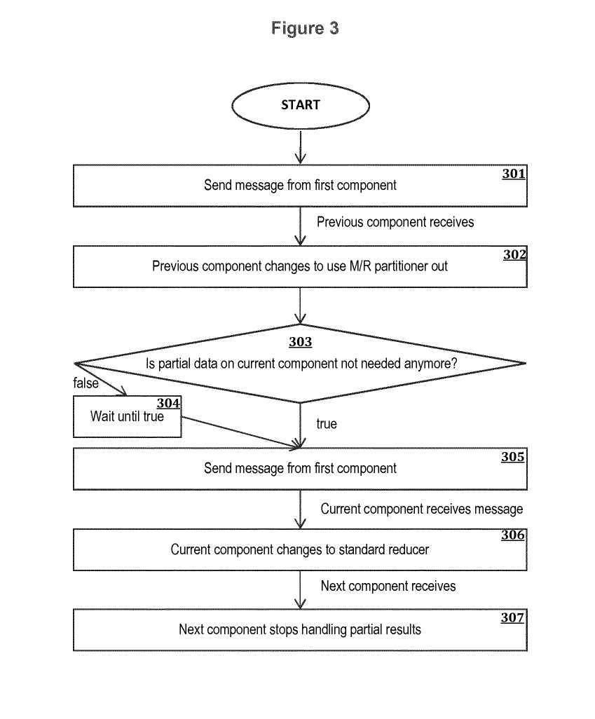

FIG. 3 is a flow diagram depicting a method of combining functions into a component, while executing.

The method starts by sending a message from the first component 301. The message will be propagated along to the components one at a time. When the previous component sees this message it will change to use its original MapReduce grouping for sending output 302. Check if data being calculated on the current component is no longer partial and the previous partial data is no longer needed 303. If not true, wait until true 304. When true a message is sent from the first component 305. This message will be propagated along till it is received by the current component. The current component should add the new functions into the logic of the current component 306. The message is then sent along to the next component which when seeing the message should stop handling partial data 307.

Method to Add Mappers to a Component

FIG. 4 is a flow diagram depicting a method of adding mappers to a component, while executing.

The method starts by checking if the component is handling partial results (means previous component is split) 401. If the component is handling partial results, the previous component needs to be combined using the method from FIG. 3 or similar before continuing 402. Mappers should then be started 403. Starting mappers can be done in different ways, our description is not limited to a specific way of doing it. Once the mappers are started the existing components needs to know about the new mappers so data and messages can be sent. This is done by updating the connections 404. Updating connections can be done in several different ways; this description is not limited to a specific way of doing it.

### Method to Remove Mappers from a Component

FIG. 5 is a flow diagram depicting a method of removing mappers from a component, while executing.

The method starts by checking if the component is handling partial results (means previous component is split) 501. If the component is split, it needs to be combined using the method from FIG. 3 or similar before continuing 502. The previous component should stop generating any output to the current component 503. The previous component should not stop sending data but only stop generating new data, as data might be buffered and sent later if the load is too high. Check if all data has been received, processed and sent on the current component 504. Wait until true 505. When true the current component will not receive any more data and it has finished processing all the data. Because mappers have no state, it is now safe to stop and remove the mappers from the component 506. It is possible to remove |component|−1 computing units from the component at one time. Update the connections to inform the rest of the components and their computing units about the removed mappers 507.

### Method to Add Reducers to a Component

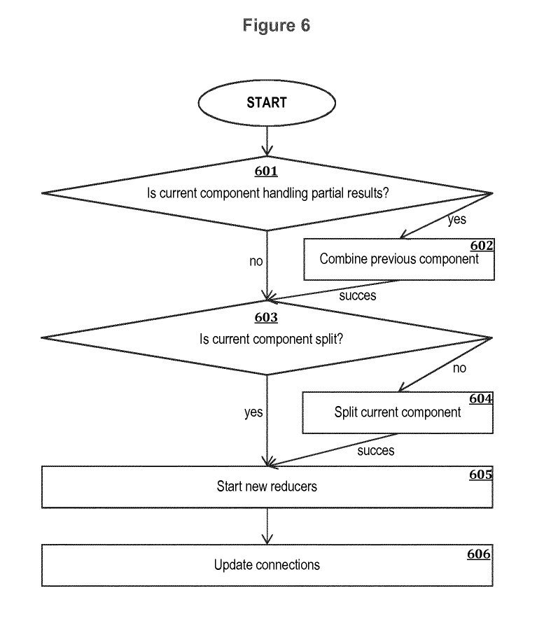

FIG. 6 is a flow diagram depicting a method of adding reducers to a component, while executing.

The method starts by checking if the current component is handling partial results (means the previous component was split) 601. If the current component is handling partial results, the previous component should be combined by using the method defined in FIG. 3 or similar 602. Check if the current component is split 603. If the current component is not split, split it using the method defined in FIG. 2 or similar 604. Start the new reducers on the current component 605. Once the reducers are started the existing components needs to know about the new reducers so data and messages can be sent. This is done by updating the connections 606.

### Method to Remove Reducers from a Component

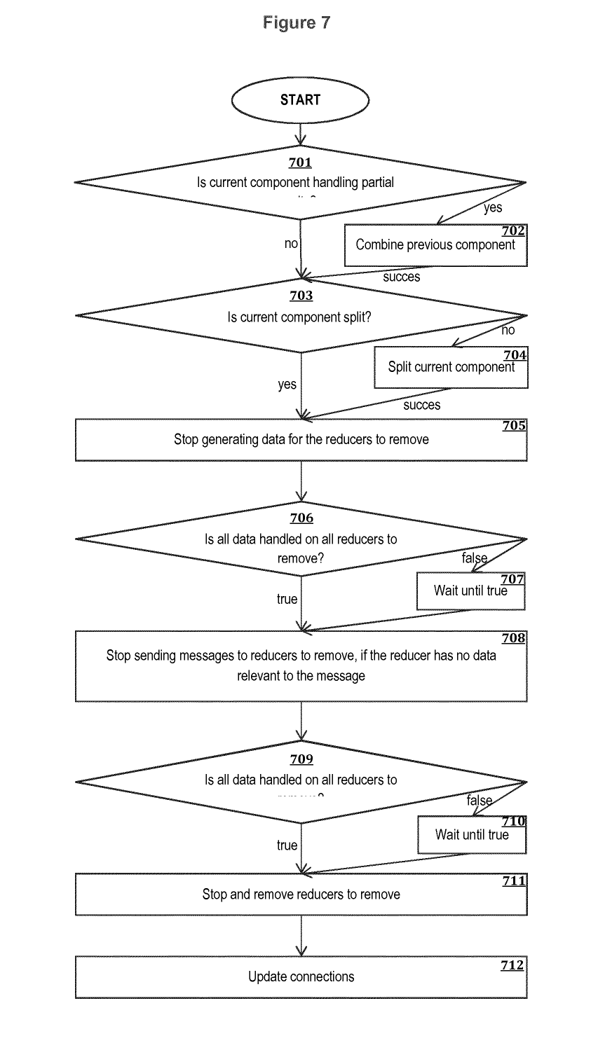

FIG. 7 is a flow diagram depicting a method of removing reducers from a component, while executing.

The method starts by checking if the current component is handling partial results (means the previous component was split) 701. If the current component is handling partial results, the previous component should be combined by using the method depicted in FIG. 3 or similar 702. Check if the current component is split 703. If the current component is not split, split it using the method depicted in FIG. 2 or similar 704. The previous component stops generating new data (messages are still generated) for the current component 705. Check if the current component has received all data and processed this 706. If not true, wait until true 707. Stop sending messages to the reducers to remove, if the message is not relevant to the data currently stored on the reducers to remove 708. This ensures the reducers to remove will eventually stop receiving messages and when this is true, it is known the data on the reducers is not needed for any computation again. Check if all messages (also future messages) have been received on the reducers to remove, and check if all calculations are done and results have been sent from the reducers to remove 709. If not true, wait until true 710. As the reducers will never receive anything and they have sent their results along, the reducers can now be stopped and removed 711. Update the existing components, to inform them about the removed reducers 712.

### Alternative Method to Combine Functions into a Component

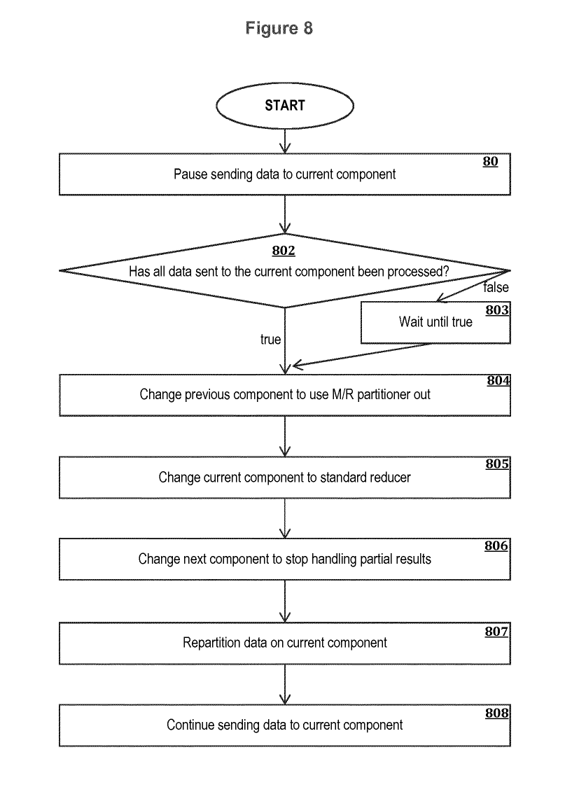

FIG. 8 is a flow diagram depicting an alternative method of combining the logic of a component, while executing.

The method starts by pausing sending data to the current component 801. A check is done to determine if all possible processing is completed at the current component 802. If not, wait 803. Then the previous component is changed to use the MapReduce partitioner for future output 804. The current component is changed to also apply the new “combined” functions 805, and the next component is changed to stop handling partial results 806, as partial results will no longer be sent. The data on the current component is then repartitioned by copying the data between the computing units of the current component 807. Lastly the previous component is instructed to continue sending data to the current component 808.

### Alternative Method to Add Reducers to a Component

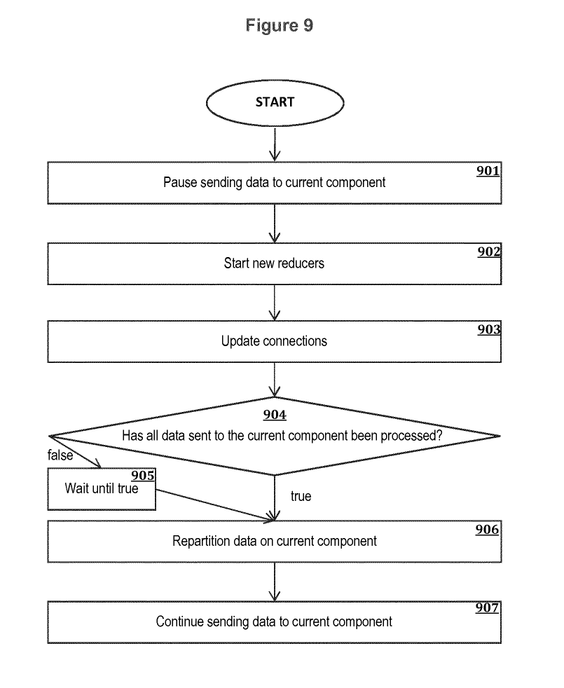

FIG. 9 is a flow diagram depicting a method of adding reducers to a component, while executing.

The method starts by pausing sending data to the current component 901. It then starts new instances of the current component 902, and updates the connections 903. Then it checks if all data is processed at the current component 904. If not, then we wait until it is true 905. It is now safe to repartition the data on the current component, by copying data between the instances 906. Lastly the previous component is instructed to continue sending data to the current component 907.

### Alternative Method to Remove Reducers from a Component

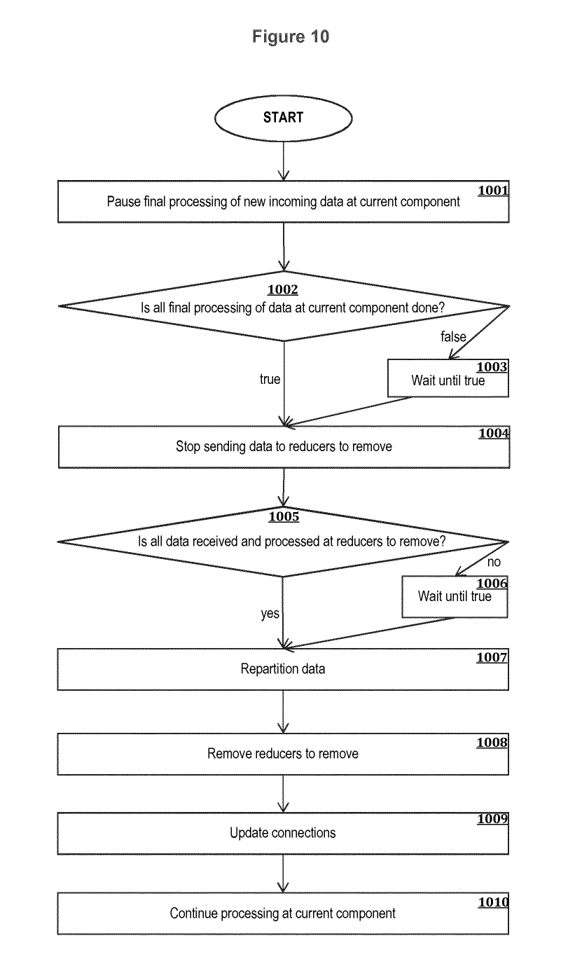

FIG. 10 is a flow diagram depicting a method of removing reducers from a component, while executing.

The method starts by pausing final processing on the current component. This is to prevent any results being produced from new incoming data, but not to pause processing 1001. The method then checks if all possible final processing is done on the current component 1002. If not, then we wait 1003. The method then orders the previous component to stop sending data to the reducers to remove 1004. In the next step it is checked if all data is received and all possible processing of that data is completed in the reducers to remove 1005. If not, then we wait 1006. It is then safe to repartition the data, such that when removing the reducers as required, the data will be placed correctly 1007. Now the reducers to remove, are removed 1008 and the connections are updated 1009. Lastly the current component is ordered to continue processing 1010.

1. A method to split the computing logic of one component, onto two components, in a job which can be specified using Map and Reduce computing units, during execution of the job, said method comprising the steps of:
Sending a message A from any component, before the first component in the job, containing either Map or Reduce computing units;
Changing the components sending data to the component to split, to shuffle output, upon receiving message A;
Changing the component to split to create partial results, upon receiving message A;
Changing the component to split to send output so that data with the same key is sent to the same computing unit, upon seeing message A;
Changing the components receiving data from the component to split, to handle partial results, upon seeing message A;
wherein;
the component is a set of computing units of the same type using the same execution logic;
a Map computing unit is a unit, which is partitioning data;
a Reduce computing unit is doing aggregation and applying some function to the aggregated data; and
a message is data, which controls the execution logic.

2. A method to combine a component, whose computing logic is split over two components, onto one component, in a job which can be specified using Map and Reduce computing units, during execution of the job, said method comprising the steps of:
Sending a message A from any component, before the first component in the job, containing either Map or Reduce computing units;
Changing the components sending data to the component to combine onto, to send output in such a way, data with same key is sent to the same computing unit, upon receiving message A;
Checking if data being calculated on the component to combine onto is no longer partial and the previous processed partial data is no longer needed;
Sending a message B from any component, before the first component in the job, containing either Map or Reduce computing units;
Changing the component to combine onto, to begin creating complete results upon receiving message B;
Changing the components receiving from the component to combine onto, to stop handling partial results, upon receiving message B;
wherein;
the component is a set of computing units of the same type using the same execution logic;
a Map computing unit, is a unit, which is partitioning data;
a Reduce computing unit is doing aggregation and applying some function to the aggregated data; and
a message is data which controls the execution logic.

3. A method to add one or more mappers to a component, in a job which can be specified using Map and Reduce computing units, during execution of the job, said method comprising the steps of:
Checking if the current component, is handling partial results;
Combining the computing logic onto the components sending to the current component, if necessary;
Starting new mappers for the component to add mappers to;
Updating the connections in the job;
wherein;
the component is a set of computing units of the same type using the same execution logic;
a Map computing unit is a unit, which is partitioning data;
a Reduce computing unit is doing aggregation and applying some function to the aggregated data;
a message is data which controls the execution logic; and
the component to add mappers to is defined as the current component.

4. A method to remove one or more mappers from a component, in a job which can be specified using Map and Reduce computing units, during execution of the job, said method comprising the steps of:
Checking if current component is handling partial results;
Combine the logic of the components sending to the current component, if necessary;
Stopping generation of new data for the mappers to remove;
Checking if all is received, processed and sent on the mappers to remove;
Stopping and removing mappers;
Updating the connections in the job;
wherein;
the component is a set of computing units of the same type using the same execution logic;
a Map computing unit is a unit, which is partitioning data;
a Reduce computing unit is doing aggregation and applying some function to the aggregated data;
a message is data which controls the execution logic; and
the component to remove mappers from is defined as the current component.

5. A method to add one or more reducers to a component, in a job which can be specified using Map and Reduce computing units, during execution of the job, said method comprising the steps of:
Checking if current component is handling partial results;
Combine the logic of the components sending to the current component, if necessary;
Checking if current components computing logic is split over two components;
If not spilt then split the logic of the current component onto two components;
Starting new reducers for the current component; and
Updating the connections in the job;
wherein;
the component is a set of computing units of the same type using the same execution logic;
a Map computing unit is a unit which is partitioning data;
a Reduce computing unit is doing aggregation and applying some function to the aggregated data;
a message is data which controls the execution logic; and
the component to add reducers to is defined as the current component.

6. A method to remove one or more reducers from a component, in a job which can be specified using Map and Reduce computing units, during execution of the job, said method comprising the steps of:
Checking if current component is handling partial results;
Combine the logic of the components sending to the current component, if needed;
Checking if current components computing logic is split over two components;
and; if not, split the logic of the current component over two components;
Stopping generation of new data for the reducers to remove on the current component;
Checking if all data has been received, processed and sent from the reducers to remove, on the current component;
Stopping sending messages for reducers to remove on the current component if the message has no relevance for the data at the reducers to remove;
Checking if all input on all the reducers to remove on the current component has been received, processed and sent;
Stopping and removing reducers to remove on the current component; and
Updating the connections in the job;
wherein;
the component is a set of computing units of the same type using the same execution logic;
a Map computing unit is a unit which is partitioning data;
a Reduce computing unit is doing aggregation and applying some function to the aggregated data;
a message is data, which controls the execution logic; and
the component to remove reducers from is defined as the current component.

7. An alternative method to combine a component, whose computing logic is split over two components, onto one component, in a job which can be specified using Map and Reduce computing units, during execution of the job, said method comprising the steps of:
Pausing sending data to the current component;
Waiting until all incoming data is processed at current component;
Changing the previous component to use a MapReduce partitioner for output;
Changing the current component to a standard reducer;
Changing the next component to stop handling partial results;
Repartition data on the current component, such that data is located on the correct computing units, according to the MapReduce partitioner of the previous component.
wherein;
the component is a set of computing units of the same type using the same execution logic;
a Map computing unit, is a unit, which is partitioning data;
a Reduce computing unit is doing aggregation and applying some function to the aggregated data; and
a message is data which controls the execution logic.

8. An alternative method to add one or more reducers to a component, in a job which can be specified using Map and Reduce computing units, during execution of the job, said method comprising the steps of:
Pausing sending data to the current component;
Starting new reducers for the current component; and
Updating the connections in the job;
Checking if all data is processed at current component; and waiting if not;
Repartition data on the current component, such that data is located on the correct computing units, according to the MapReduce partitioner of the previous component;
Continuing sending data to the current component.
wherein;
the component is a set of computing units of the same type using the same execution logic;
a Map computing unit is a unit which is partitioning data;
a Reduce computing unit is doing aggregation and applying some function to the aggregated data;
a message is data which controls the execution logic; and
the component to add reducers to is defined as the current component.

9. An alternative method to remove one or more reducers from a component, in a job which can be specified using Map and Reduce computing units, during execution of the job, said method comprising the steps of:
Pausing new output on the current component, without requiring the actual processing to stop;
Checking if all possible outputs have been calculated on the current component;
Stopping sending data to the reducers to remove
Checking if all input on all the reducers to remove has been received, processed and sent;
Repartition data on the current component, such that data is located on the correct computing units, according to the MapReduce partitioner of the previous component.
Stopping and removing reducers to remove; and
Updating the connections in the job;
Continue sending new output from the current component;
wherein;
the component is a set of computing units of the same type using the same execution logic;
a Map computing unit is a unit which is partitioning data;
a Reduce computing unit is doing aggregation and applying some function to the aggregated data;
a message is data, which controls the execution logic; and
the component to remove reducers from is defined as the current component.
